(19) United States
(12) Patent Application Publication
(10) Pub. No.: US 2011/0189587 A1
(43) Pub. Date: Aug. 4, 2011

(54) Interconnect Member for Fuel Cell

(75) Inventors: Aaron T. Crumm, Ann Arbor, MI (US); Timothy LaBreche, Ann Arbor, MI (US)

(73) Assignee: ADAPTIVE MATERIALS, INC., Ann Arbor, MI (US)

(21) Appl. No.: 12/698,031

(22) Filed: Feb. 1, 2010

(51) Int. Cl. H01M 8/10

(52) U.S. Cl. 429/495

(57) ABSTRACT

A solid oxide fuel cell includes a plurality of fuel cell tubes. Each fuel cell includes an active area and an anode outer surface disposed downstream the active area. The solid oxide fuel cell tube further includes an interconnect member disposed circumferentially around the fuel cell tube electrically contacting the anode outer surface.

### CROSS-REFERENCE TO RELATED APPLICATIONS

This application claims benefit of U.S. Provisional Patent Application No. 61/206,457 the entire contents of which is hereby incorporated by reference herein. This application is a continuation-in-part of U.S. patent application Ser. No. 11/566,457 filed on Dec. 4, 2006, which is a continuation-in-part of U.S. patent application Ser. No. 10/991,268 filed on Nov. 17, 2004, which claims priority benefit of U.S. Provisional Patent Application No. 60/520,839 filed on Nov. 17, 2003. The entire contents of U.S. patent application Ser. No. 12/044,355 is hereby incorporated by reference herein.

### GOVERNMENT INTERESTS

This invention was made with government support under contract number W909MY-08-C-0025, awarded by the U.S. Department of Defense. The government has certain rights in this invention.

### FIELD OF THE INVENTION

This invention relates to electrical current conduction among solid oxide fuel cells.

### BACKGROUND OF THE INVENTION

A solid oxide fuel cell (SOFC) can react a fuel gas and an oxidant on opposite sides of an electrolyte to generate DC electric current. SOFCs have an anode, an electrolyte and a cathode, and can be made from a variety of materials and in a variety of geometries. Solid oxide fuel cell systems can convert hydrocarbon fuels such as butane (C₄H₁₀), propane (C₃H₈) or diesel fuel (JP-8 or JET-A) to a suitable fuel gas containing carbon monoxide (CO) and hydrogen (H₂). CO and hydrogen gas are then oxidized at an active area of a SOFC to produce carbon dioxide and water, with DC current generated. Non hydrocarbon fuels such as ammonia (NH₃) can also be transformed into SOFC fuel using one or more catalytic reactions.

Current collectors are used on known SOFCs to collect electric current generated by the solid oxide fuel cells. The operating environment of the fuel cell current collector includes high temperature oxidative environments, high temperature reducing environments, and combustion environments. The operating temperatures at the anode and cathode of the fuel cell are in the range of about 600-950° C. The operating temperature at a flame tip region proximate an exhaust outlet of the solid oxide fuel cell can include temperatures of 1000° C. and above.

Known current collectors used in tube-shaped SOFC designs include the so-called “Westinghouse” design where a strip of a lanthanum-chromite ceramic runs along the length of the fuel cell, and a nickel felt electrically connects an electrode of one tube to an electrode of another tube. This design is disadvantageous for several reasons, including the expense of the nickel felt, the low mechanical strength of the nickel felt, thermal expansion mismatch between the nickel felt and other fuel cell materials, and low flexibility in positioning the fuel cells to address heat dissipation concerns. Portable fuel cell designs can be subject to physical stresses and shocks, etc., and current collectors must maintain operation when being subjected to the stresses and shocks.

It has also been known to use silver wires as current collectors, as they are capable of operating in high temperatures and are resistant to oxidation. However, silver wires can be degraded in the high temperature oxidative environment of the flame tip. It would be desirable to provide a solid oxide fuel cell with a current collector system capable of efficiently conducting current while withstanding degradation from thermal cycling and physical stresses within the reducing and oxidizing SOFC environment.

### SUMMARY

In accordance with exemplary embodiments described herein, a solid oxide fuel cell includes a plurality of fuel cell tubes and an interconnect member. Each fuel cell tube includes an anode layer, an electrolyte layer and a cathode layer. The anode layer comprises an anode outer surface having a first area and a second area. The first area includes the electrolyte layer disposed thereon and the electrolyte layer includes an outer surface with the cathode layer disposed thereon. The portion of the tube having the anode layer, electrolyte layer, and cathode layer defines an active area. The second area of the anode outer surface is downstream the active area. The interconnect member is disposed circumferentially around the fuel cell tube. The interconnect member electrically contacts the second area of the anode outer surface.

### BRIEF DESCRIPTION OF THE DRAWINGS

FIG. 1 is a schematic diagram depicting a fuel cell system in accordance with an exemplary embodiment of the present disclosure;

FIG. 2 is a top view of a portion of a fuel cell stack of the fuel cell system of FIG. 1;

FIGS. 3 depicts a prospective view of a plurality of fuel cells and a current collecting system of the fuel cell stack of FIG. 2;

FIG. 4 depicts cross sectional a view of a first cross section of the current collecting system and the fuel cell of FIG. 3;

FIG. 5 depicts a cross sectional view of a second cross section of the current collecting system and a fuel cell of the plurality of fuel cells of FIG. 3; and

FIG. 6 depicts a prospective view of a portion of the current collecting system of FIG. 3.

### DETAILED DESCRIPTION OF THE PREFERRED EMBODIMENTS

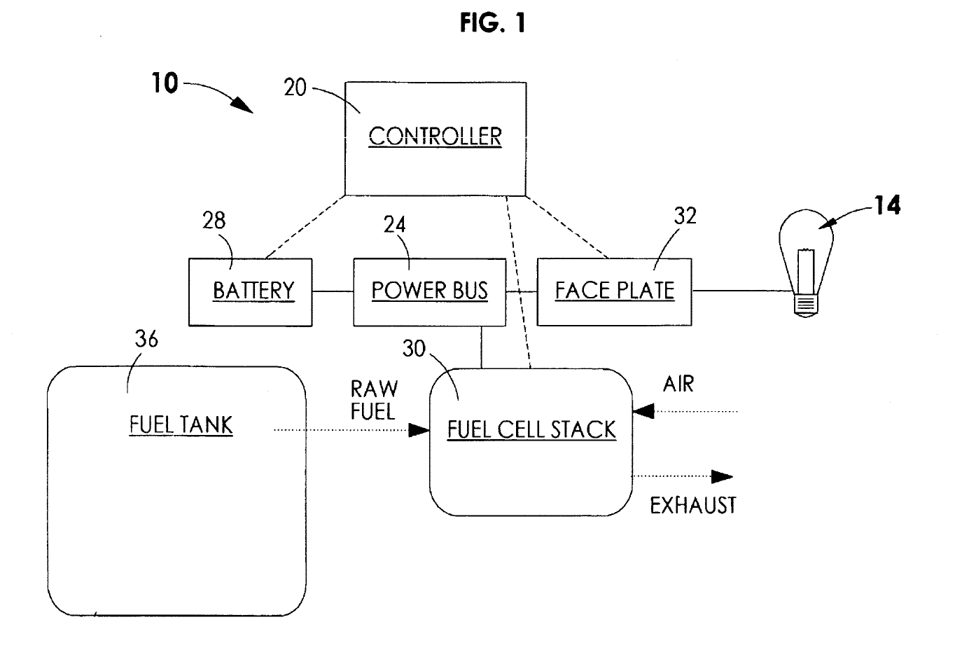

FIG. 1 depicts a fuel cell system 10 electrically coupled to an external device 14. The fuel cell system 10 includes a controller (‘ CONTROLLER’) 20, a power bus (‘POWER BUS’) 24, a battery (‘BATTERY’) 28, a fuel cell stack (‘FUEL CELL STACK’) 30, a face plate (‘FACE PLATE’) 32, and a fuel tank (‘FUEL TANK’) 36.

The controller 20 comprises a general-purpose digital computer comprising a microprocessor or central processing unit, storage mediums comprising non-volatile memory, a high speed clock, analog-to-digital conversion circuitry, input/output circuitry and devices, and appropriate signal conditioning and buffer circuitry. The controller 20 can execute a set of algorithms comprising resident program instructions to monitor control signals from sensors disposed throughout the fuel cell system 10 and can execute algorithms in response to the monitored inputs to execute diagnostic routines to monitor power flows and component operations of the fuel cell system 10.

The power bus 24 comprises an electrically conductive network configured to route power from the energy conversion devices (the rechargeable battery 28 and the fuel cell stack 30) to the face plate 32. The face plate 32 comprises a plurality of electrical connection ports for connecting external devices 14 to the fuel cell system 10. The exemplary rechargeable battery 28 is configured to receive power from the power bus 24 and to discharge power to the power bus 24.

The fuel tank 36 contains the fuel pump 34 that delivers raw fuel from the fuel tank 36 to the fuel cell stack 30. Raw fuel, as used herein refers to fuel prior to being processed by fuel cell stack 30 as described herein below. Exemplary raw fuels include a wide range of hydrocarbon fuels. In an exemplary embodiment, the fuel is a mixture comprising combinations of various component fuel molecules, examples of which include gasoline blends, liquefied natural gas, JP-8 fuel and diesel. In alternative embodiments, the raw fuel can comprise one or more other types of fuels, such as alkane fuels, for example, methane, ethane, propane, butane, pentane, hexane, heptane, octane, nonane, decane, along with hydrocarbon molecules with greater number of carbon atoms such as cetane, and the like, and can include non-linear alkane isomers. Further, other types of hydrocarbon fuel, such as partially and fully saturated hydrocarbons, and oxygenated hydrocarbons, such as alcohols and glycols, can be utilized as raw fuel that can be converted to electrical energy by the fuel cell stack 30.

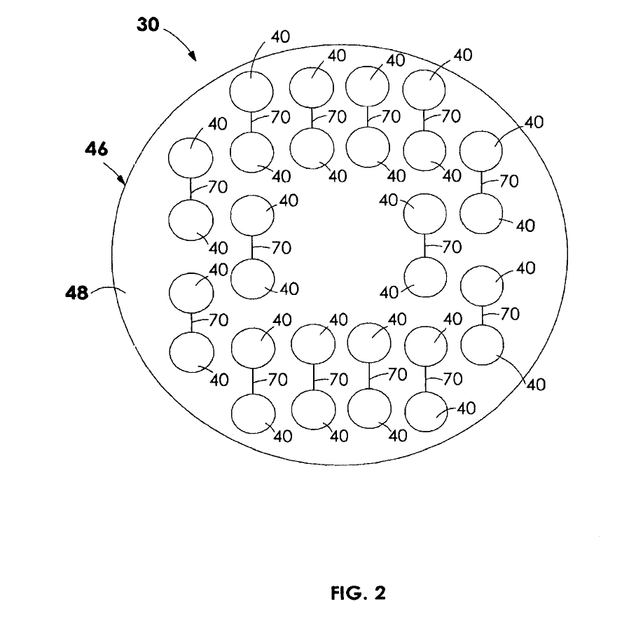

Referring to FIG. 2, the fuel cell stack 30 comprises a plurality of fuel cell tubes 40, a current collecting system 70, and an insulative body 46. The insulative body 46 defines an insulative cavity 48, and the plurality of fuel cells 40 are disposed within the insulative cavity 48. Each of the plurality of fuel cell tube 40 are electrically connected via the current collecting system 70. The insulative body 46 can include a high-temperature, ceramic-based material comprising, for example, alumina, silica, and like materials. Atmospheric air is provided to the insulative cavity 48 and is utilized as an oxidant source for reactions on the outer surface of each fuel cell tube 40. As is explained in further detail below, each fuel cell tube 40 generates electric current, which can be collected at an electrode disposed at an inner surface of each fuel cell tube 40 and an electrode disposed at an outer surface of each fuel cell tube 40.

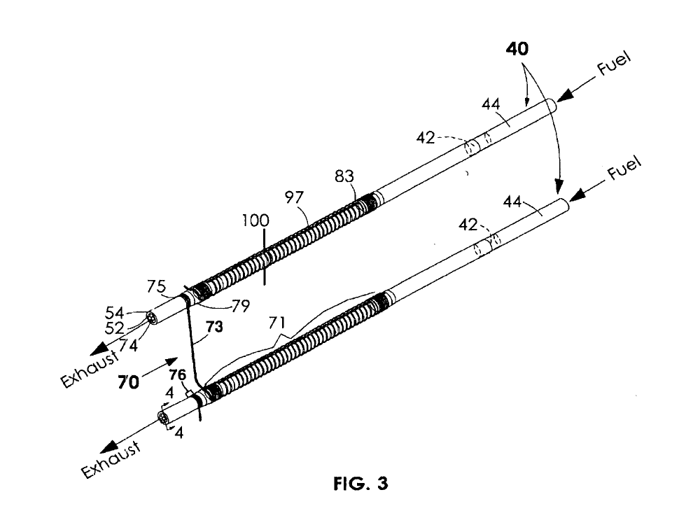

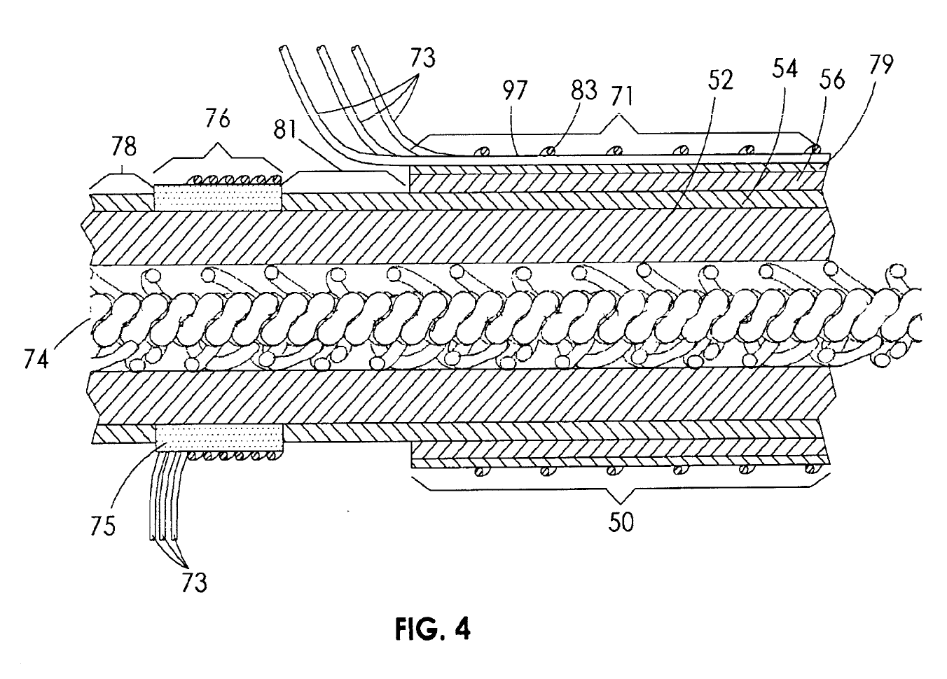

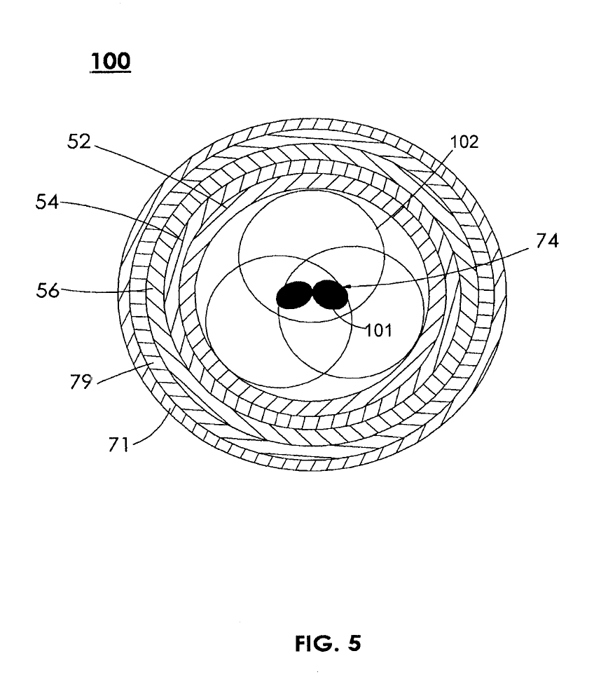

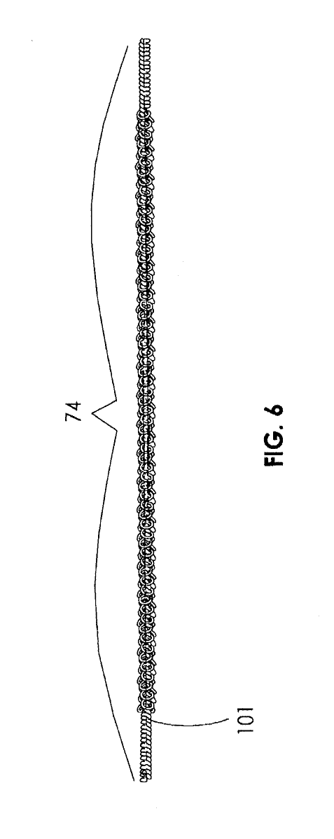

Referring to FIGS. 3-5, FIG. 3 depicts an exemplary embodiment of fuel cell tubes 40 being electrically connected by the current collecting system 70. FIG. 4 depicts exemplary fuel cell tube 40 and a portion of the current collecting system 70 along a cross-section 4 (shown in FIG. 3), and FIG. 5 depicts exemplary fuel cell tube 40 and a portion of the current collecting system 70 along a cross-section 100 (shown in FIG. 3). The current collecting system 70 includes an anode current collector 74 (also shown in FIG. 6), an interconnect member 76, and a cathode current carrier 71. In an exemplary fuel cell stack 30, the fuel cells are arranged in a series connection of fuel cell tubes 40 producing DC power at a voltage which is a sum of the potential of the individual fuel cells. Alternatively, fuel cell electrodes can be connected in parallel or in a combination with some electrodes connected in series and some electrodes in parallel.

Each fuel cell tube 40 comprises an anode layer 52 and an electrolyte layer 54 on an exterior surface of the anode layer 52. Each fuel cell tube 40 further comprises a cathode layer 56 disposed on a portion of the electrolyte layer 54 to define an active area 50. The active area 50 comprises the portion of the fuel cell tube 40 at which electromotive force is generated across the electrolyte 54 and current is generated at an active portion of the anode layer 52. Each of the fuel cell tube 40 further comprise a fuel feed tube 44 having an internal reformer 42 disposed therein.

In an exemplary embodiment, the fuel cells are advantageously relatively light in weight, and provide good power density to mass ratios. As an example of a lightweight design each tube can comprise a 1 mm-20 mm diameter tube. Thin, lightweight tubes are also advantageous in that the tubes hold less heat, allowing the fuel cell to be heated rapidly. An example of a suitable fuel cell tube is disclosed in U.S. Pat. No. 6,749,799 to Crumm et al, entitled METHOD FOR PREPARATION OF SOLID STATE ELECTROCHEMICAL DEVICE and is hereby incorporated by reference. Other material combinations for the anode, electrolyte and cathode, as well as other cross section geometries (triangular, square, polygonal, etc.) will be readily apparent to those skilled in the art given the benefit of this disclosure.

Each fuel cell tube 40 defines an inner chamber therein and includes openings at a fuel inlet end (‘FUEL’) and an exhaust end (‘EXHAUST’). In an exemplary embodiment, the active area 50 is disposed in closer proximity to the exhaust opening than the fuel inlet opening, so that fuel is routed the length of the fuel cell tube 40 and through fuel reforming reactor 42 prior to being provided to the active area 50. In an alternate embodiment comprising an anode layer positioned on an exterior of the fuel cell and a cathode layer positioned on an interior of the fuel cell, a cathode current collector having a substantially similar design to the anode current collector 71 can be disposed on the interior of the fuel cell tube.

In general, the anode layer 52 and the cathode layer 56 are formed of porous materials capable of functioning as an electrical conductor and capable of facilitating the appropriate reactions. The porosity of these materials allows dual directional flow of gases (e.g., to admit the fuel or oxidant gases and permit exit of the byproduct gases). The anode layer 52 comprises an electrically conductive cermet that is chemically stable in a reducing environment. In an exemplary embodiment, the anode comprises a conductive metal such as nickel, disposed within a ceramic skeleton, such as yttria-stabilized zirconia. The cathode layer 56 comprises a conductive material chemically stable in an oxidizing environment. In an exemplary embodiment, the cathode layer 56 comprises a perovskite material and specifically lanthanum strontium cobalt ferrite (LSCF). In an alternative exemplary embodiment, the cathode layer 56 comprises lanthanum strontium manganite.

The electrolyte layer 54 comprises a dense layer preventing molecular transport, therethrough. Exemplary materials for the electrolyte layer 54 include zirconium-based materials and cerium-based materials such as yttria-stabilized zirconia and gadolinium-doped ceria, and can further include various other dopants and modifiers to affect ion conducting properties. The anode layer 52 and the cathode layer 56, which form phase boundaries with the electrolyte layer 54, are disposed on opposite sides of the electrolyte layer 54 with respect to each other.

The fuel reforming reactor 42 is disposed within the fuel feed tube 44 positioned within the inner chamber 58 and spaced upstream (as defined by flow of fuel gas) from and proximate to the active area 50. In an exemplary embodiment, the fuel feed tube 44 comprises a dense ceramic material such as alumina and zirconia. In an alternative embodiment, the fuel feed tube can comprise a metal such as stainless steel. The fuel reforming reactor 42 reforms hydrocarbon fuel to hydrogen by catalyzing a partial oxidizing reaction between the hydrocarbon and oxygen. In an exemplary embodiment, the fuel reforming reactor 42 comprises a supported catalyst. The supported catalysts include very fine scale catalyst particles supported on a substrate. Preferably the catalytic substrate is provided with a series of openings which the fuel gas passes through as the partial oxidation reaction is catalyzed. The fuel reforming reactor 42 can comprise, for example, particles of a suitable metal such as platinum or other noble metals such as palladium, rhodium, iridium, osmium, or their alloys disposed on a substrate which can comprise oxides (such as aluminum oxide), carbides, and nitrides. In other embodiments, the catalytic substrate can include a wire, a porous bulk insert of a catalytically active material, a thin “ribbon” which having a high surface area to volume ratio or a packed bed of catalytic substrate beads. Other materials suitable for use as a catalytic substrate will be readily apparent to those skilled in the art given the benefit of this disclosure. The a fuel feed tube 44 routes bulk fuel flow in a generally uniform direction past the fuel reforming reactor 42 such that substantially all the raw fuel is catalyzed within the fuel reforming reactor prior to contacting the anode layer 52.

The cathode current collector 71 is disposed around the fuel cell tubes 40, preferably at or near the active area 50 to capture electric current generated when the oxidizing gases react at the cathode layer 56. An exemplary cathode current collector 71 comprises at least one wire which has a linear segment 97 extending parallel to the longitudinal axis of the tube and a spiral segment 83 wrapped around the linear segment 97 to maintain contact between the linear segments to the cathode layer 56 and to collect current generated circumferentially at the cathode layer 56. The cathode current collector 71 can comprise, for example, fine gauge wire allowing the wires to be somewhat flexible. A single large gauge wire may be too stiff, as it is advantageous to allow to provide material having flexibility in the fuel cell to absorb energy when subjected to irregular stresses. Irregular stresses and shock loading would be expected with a portable, lightweight solid oxide fuel cell. An example of a suitable wire for use in such cathode current collector is 250 micron silverwire. In other embodiments, the wires of the cathode current collector 71 can comprise high temperature metals or metal alloys having oxidation resistance at 600 to 900° C. examples of which include platinum, palladium, gold, silver, iron, nickel and cobalt-based materials. In general, it is desirable to reduce ohmic loss and cathode overpotential. Further, the cathode current collector 71 is electrically conductive (so that electrons generated as a result of the electrochemical reaction of the fuel cell tube 40 can be collected) and permeable to oxygen (so that oxygen can reach the active area and enter the electrochemical reaction).

In an exemplary embodiment, a contact layer 79 is disposed at an interface between the cathode current collector 71 and the cathode layer 56 that functions to reduce ohmic loss and cathode overpotential. In an exemplary embodiment, the contact layer 79 is applied as a layer about 10 to 40 microns thick prior to positioning the cathode current collector 71 around the cathode layer 56. In an exemplary embodiment, the contact layer 79 comprises gold. In an alternative embodiment, a contact layer disposed between the cathode and the cathode current collector can comprise perovskite, the cathode current collector 71 is exposed to air (oxygen) and high temperatures, and therefore, must maintain high conductivity at these temperatures. In another embodiment, the contact layer 79 can comprise silver, for example a SPI 5002 HighPurity Silver Paint from Structure Probe, Inc. silver paint over the active area 44 in a layer about 10 to 100 microns thick. In another embodiment, the wires of the cathode current collector 71 can comprise an environmentally protective outer layer and an inner core as described further herein below.

The electrolyte is substantially resistive of electron conduction, and forms a nonconductive gap 81 around the exterior of each tube between the active area 50 and an interconnect area 76. Electrical connection between the anode and outside the tube is accomplished at the interconnect member 76, where a conductive sealant 75 is applied. In addition to being electrically conductive, the conductive sealant 75 must also be oxidative and reductive resistant, it must be relatively insensitive to high temperatures, it must be gas impermeable (not porous) and it must bind to the substrate below, the anode layer 52. As an example of a suitable material for the conductive sealant 75 is a frit containing a noble metal or noble metal alloy may be used which extends circumferentially around the anode 49. An example is the platinum fit Conductrox 3804 Pt Conductor manufactured by Ferro Electronic Materials. Other materials suitable for use as a conductive sealant, include noble metals and their alloys, conductive oxides, and high temperature alloys.

The exemplary interconnect member 76 comprises a metallic wire is disposed circumferentially around each fuel cell tube 40. As shown in FIG. 4, the interconnect member comprises a plurality of filaments 73 wrapped around the fuel cell tube. In embodiment, the interconnect member is connected to the cathode current collector 71 such that the fuel cell tubes are connected in a series arrangement. In an alternative embodiment, the interconnect member 76 is connected to another interconnect member 76 such that the fuel cell tubes are connected in parallel arrangement. In one embodiment, the interconnect member 76. In an exemplary embodiment, the interconnect member 76 comprises the same material as the cathode current collector 71 and the interconnect member 76 and the cathode current collector 71 form a continuous segment. In an exemplary embodiment, the interconnect member and the cathode current collector comprise multiple wire filaments disposed between the fuel cell tubes wherein the interconnect member 76 is disposed around a portion of the fuel cell tube 40 electrically contacting the anode layer 52 and the cathode current collector is disposed around the cathode layer 56 of the fuel cell tube 40.

The anode current collector 74 comprises a wire brush having an inner portion 101 and a plurality of loop members 102 extending therefrom. The wire diameters may preferably be set so that the wire brush fit snugly inside the tube to promote good electrical contact with that anode while leaving space between the portions of the wire brush for the passage of gas. The anode current collector 74 comprises an electrically conducting metal. Since the wire brush member positioned in the processed fuel gas, the anode current collector 74 is formed from material that maintains conductivity in the operating environment of the inner chamber of the fuel cell tube 40. In exemplary inner chamber, the oxygen level, the reducing gas level, and the operating temperature maintain an environment providing sufficiently low rates of copper oxidation such that the anode current collector 74 can comprise copper or a copper alloy.

An anode contact layer (not shown) can physically and electrically connect the anode layer 52 to the anode current collector 74. The anode contact layer is porous to allow the fuel gas to be routed therethrough and can comprise, for example, a paint containing copper oxide which is applied to the wire or wires of the anode current collector 74 prior to insertion into the inner chamber of the fuel cell tube 40. Upon heating in the fuel gas atmosphere, the copper oxide particles in the paint reduce to copper metal, creating a porous sintered metal contact between the anode current collector and the anode layer 52. Other materials suitable for creating a porous contact include metal oxides such as nickel oxide. In alternate embodiments, the anode can be connected to the anode current collector utilizing other methods including sinter bonding and brazing.

The anode current collector 74 is mechanically compliant relative to the anode 74. The term “mechanically compliant” refers to the ability of the brush portion of the anode current collector 74 to distribute forces created by differing thermal expansion profiles between the anode current collector and the material forming the fuel cell tube 40 so that the brush portion maintains contact with the anode layer 52. In an alternative embodiment, the loop members 102 of the brush portion can be attached to the anode layer 52 by welding or brazing.

In operation, processed fuel gas flows through each of the tubes, arriving at the active area 44 first, then passing the insulating gap area 81. Insulating gap 81 is insulating on the exterior of the tubes, as the anode and any conducting materials at the interior of the tube with respect to the electrically nonconducting electrolyte. From the gap area, the exhaust gases and remaining gases pass through the interconnect area 76 to the burner area 78 and ejected outside the tube where any remaining processed gas may be burned. Advantageously, the anode current collector wires need only extend from the burner region to the active area.

Whether the electrodes of the tubes are electrically connected in series or in parallel, the cathode current collector 71 and anode current collector 74 are designed to collect current from all of the tubes and transmit that current out of the thermal enclosure 12. When connected in series, all but a last one of the cathode current collectors 71 connects the cathode of one tube to the anode of another tube. As shown schematically in FIG. 9, the anode current collector wire from the last anode and the cathode current collector wire from the last cathode in a chain of SOFC tubes connected in series are electrically connected to an external electrical load. Advantageously, only two sets of silver wires leave the thermal enclosure 12, reducing heat loss from the thermal enclosure, one set from the last cathode, and one set from the last anode, at the interconnect area.

The interconnect member 72 electrically and physically couples the anode current collector 74 to the cathode current collector 71. In other embodiment, the interconnect member can electrically and physically couple another current collector in a parallel configuration. Additionally, the interconnect member 76 may can act as an electrically lead at a beginning or at an end of a series of fuel cells. The interconnect member 76 may also be used as a lead, when utilized in a first or last fuel cell of a series circuit or parallel circuit fuel cell belt. The interconnect member 76 may be the lead extending out of the fuel cell or it may be further connected to a lead wire that extends out of the fuel cell.

In alternate embodiments, the current collecting system can comprise an environmentally protective outer layer and an inner core. Further, the wire utilized for current collection systems such as the current collection system 70 can comprise any one of a variety of cross-sectional constructions. For a further description of interconnect system wire form factors refer to U.S. patent application Ser. No. 12/044,355 entitled CLAD COPPER WIRE HAVING ENVIRONMENTALLY ISOLATING ALLOY, which hereby incorporated by reference.

Since the current collecting systems in accordance with exemplary embodiments of the present disclosure to collect current at an outer surface of the fuel cell tube 40, the current collecting systems can comprise a relatively short length (as opposed to being disposed through the inlet or outlet opening) and can thereby experience less resistive loss than prior art solid oxide fuel cell current collecting systems. Further, since the current collecting system 70 is not disposed in the exhaust opening of the fuel cell tubes 40, the current collecting system is not subject to the high temperature corrosive environments of the exhaust openings.

From the foregoing disclosure and detailed description of certain preferred embodiments, it will be apparent that various modifications, additions and other alternative embodiments are possible without departing from the true scope and spirit of the invention. The embodiments discussed were chosen and described to provide the best illustration of the principles of the invention and its practical application to thereby enable one of ordinary skill in the art to use the invention in various embodiments and with various modifications as are suited to the particular use contemplated. All such modifications and variations are within the scope of the invention as determined by the appended claims when interpreted in accordance with the breadth to which they are fairly, legally, and equitably entitled.

1. A solid oxide fuel cell comprising:
a plurality of fuel cell tubes, each fuel cell tube comprising an anode layer, an electrolyte layer and a cathode layer; the anode layer comprising an anode outer surface having a first area and a second area, the first area having the electrolyte layer disposed thereon, the electrolyte layer having an outer surface with the cathode layer disposed thereon, the portion of the tube having the anode layer, the electrolyte layer, and the cathode layer defining an active area, the second area of the anode outer surface being downstream the active area; and
an interconnect member disposed circumferentially around the fuel cell tube, the interconnect member electrically contacting the second area of the anode outer surface.

2. The fuel cell system of claim 1, wherein the interconnect member comprises a metallic wire disposed circumferentially around the fuel cell tube.

3. The fuel cell of claim 2, wherein the interconnect member further comprises a contact layer providing electrical contact between the metallic wire and the anode layer of the fuel cell tube.

4. The fuel cell system of claim 2, wherein the interconnect member comprises a metallic wire comprising a plurality of filaments disposed around the fuel cell tube.

5. The fuel cell system of claim 2, wherein the wire is wrapped around the fuel cell tube.

6. The fuel cell system of claim 2, wherein the wire comprises one of silver and a silver alloy.

7. The fuel cell system of claim 1, wherein the wire conducts current between the outer surface of the second area of the anode outer surface and a fuel cell tube outer surface of a second fuel cell.

8. The fuel cell system of claim 1, wherein the plurality of fuel cells are electrically connected in a parallel arrangement.

9. The fuel cell system of claim 1, wherein the plurality of fuel cells are electrically connected in a series arrangement.

10. The fuel cell system of claim 1, further comprising an anode current carrier, said anode current carrier having a different material composition than the anode, wherein the second area of the second area of the anode outer surface is disposed circumferentially around the anode current carrier.

11. The fuel cell system of claim 1, wherein the anode current carrier comprises a brush member.

12. The fuel cell system of claim 1, wherein the anode current carrier comprises a core member.

13. The fuel cell system of claim 1, wherein the anode current carrier comprises copper.

14. The fuel cell system of claim 1, wherein the interconnect member is connected with a cathode current collector disposed in electrical contact with a cathode of a second fuel cell tube, the cathode current collector comprising a metallic wire having a first portion extending parallel to a longitudinal axis of the second fuel cell tube.

15. The fuel cell system of claim 14, wherein the cathode current collector further comprises a second portion disposed circumferentially around the second fuel cell tube.

16. The fuel cell system of claim 14, wherein the cathode current collector comprises multiple filaments.

17. The fuel cell system of claim 1, wherein the fuel cell tube comprises a coextruded anode layer and electrolyte layer, wherein a portion of the electrolyte layer is removed to define the second area of the anode outer surface.

18. The fuel cell system of claim 1, wherein a fuel reforming reactor is disposed within the fuel cell tube upstream the active area of the tube.

19. A solid oxide fuel cell comprising:
a plurality of fuel cell tubes, each fuel cell tube comprising an anode layer, an electrolyte layer and a cathode layer;
the anode layer comprising an anode outer surface having a first area and a second area, the first area having electrolyte disposed thereon, the electrolyte having an outer surface with the cathode layer disposed thereon, the portion of the tube having the anode layer, electrolyte layer, and cathode layer defining an active area, the second area of the anode outer surface being downstream the active area; and
an wire disposed circumferentially around a first fuel cell tube to electrically contacting the second area of the anode outer surface and disposed in electrical contact with the cathode of a second fuel cell tube.

20. The solid oxide fuel cell of claim 19 wherein the wire comprises multiple filaments.
